(19) United States
(12) Patent Application Publication
(10) Pub. No.: US 2008/0198440 A1
(43) Pub. Date: Aug. 21, 2008

(54) ACTIVE REFLECTIVE POLARIZER AND MAGNETIC DISPLAY PANEL COMPRISING THE SAME

(75) Inventor: Sung Nae CHO, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/031,861

(22) Filed: Feb. 15, 2008

(30) Foreign Application Priority Data
Feb. 16, 2007 (KR) 10-2007-0016783
May 11, 2007 (KR) 10-2007-0046199
Sep. 5, 2007 (KR) 10-2007-0089961

(51) Int. Cl. G02F 1/09

(52) U.S. Cl. 359/280

(57) ABSTRACT

Provided are an active reflective polarizer and a magnetic display panel comprising the same. The active reflective polarizer includes a magnetic material layer in which magnetic moments are arranged in one direction when a magnetic field is applied; and electrodes for applying magnetic fields to the magnetic material layer in two different directions.

### CROSS-REFERENCE TO RELATED PATENT APPLICATION

This application claims the benefit of Korean Patent Application No. 10-2007-0016783, filed on Feb. 16, 2007, No. 10-2007-0046199, filed on May 11, 2007, and No. 10-2007-0089961, filed on Sep. 5, 2007, in the Korean Intellectual Property Office, the disclosure of which is incorporated herein in their entireties by reference.

### BACKGROUND OF THE INVENTION

1. Field of the Invention

Apparatuses consistent with the present invention relate to an active reflective polarizer and a magnetic display panel comprising the same, and more particularly, to a bistable active reflective polarizer and a bistable magnetic display panel comprising the same.

2. Description of the Related Art

A liquid crystal display (LCD) panel is non-emissive, and thus it has to use an optical shutter that transmits/blocks light emitted from a backlight unit or other external light. When an optical shutter used in an LCD panel is formed of two polarizing plates and a liquid crystal layer arranged between the two polarizing plates. The liquid crystal layer merely rotates the polarization of light. A polarizing plate formed on the side of a light source is called a polarizer, and the polarizing plate formed on the opposite side of the light source is called an analyzer. The polarizing axes of the analyzer and the polarizer are at an angle of 90°.

As un-polarized light emitted from a backlight unit (BLU) passes through the polarizer, one polarization light is selected and arrives at the analyzer through the liquid crystal layer, and whether the light passes through the analyzer or not depends on the amount by which the polarization light is rotated by the liquid crystal layer. Since the polarization axes of the analyzer and the polarizer are perpendicular to each other, if the liquid crystal layer rotates even a small amount of light, light corresponding to that amount passes through the analyzer, and if the liquid crystal does not rotate any light, the light cannot pass through the analyzer. One of the critical issues for an LCD is a wide viewing angle, and liquid crystal modes used to provide a wide viewing angle are expensive to manufacture. Accordingly, research into developing inexpensive liquid crystal modes so as to provide a wide viewing angle has been conducted. In addition, the LCD has a low response speed, and thus problems such as motion blur occur.

### SUMMARY OF THE INVENTION

The present invention provides an active reflective polarizer using magnetic materials instead of liquid crystals and a magnetic display panel comprising the active reflective polarizer.

The present invention also provides an electronic device comprising the magnetic display panel.

According to an aspect of the present invention, there is provided an active reflective polarizer comprising: a magnetic material layer in which magnetic moments are arranged in one direction when a magnetic field is applied; and electrodes for applying magnetic fields to the magnetic material layer in two different directions.

Light having a magnetic component parallel to the arrangement direction of magnetic moments of the magnetic material layer may be reflected at the magnetic material layer, and light having a magnetic component perpendicular to the arrangement direction may be transmitted through the magnetic material layer.

According to the present invention, the arrangement direction of the magnetic moments of the magnetic material layer may be varied by varying the intensity of the magnetic fields applied in the two different directions, respectively.

For example, the arrangement direction the magnetic moments of the magnetic material layer may be controlled is within the range of 90 degrees, between the y-axis and the x-axis.

The magnetic material layer may have a structure in which magnetic particles are buried in a transparent insulating medium.

The thickness of the magnetic material layer may be greater than the magnetic decay length of the magnetic material layer.

For example, the magnetic material layer may have a core-shell structure formed of magnetic cores formed of magnetic bodies having conductivity and transparent insulating shells around the magnetic cores.

The insulating shells may be formed of transparent insulating material surrounding the cores.

Alternatively, the insulating shells may be formed of transparent insulating surfactant in the form of polymer surrounding the cores.

The magnetic bodies forming the magnetic cores may comprise one of metals selected from the group consisting of iron, cobalt, nickel, titanium, aluminum, barium, platinum, natrium, magnesium, dysprosium, manganese, gadolinium, silver, copper, and chromium, or an alloy thereof

The magnetic bodies may be ferromagnetic, paramagnetic, or superparamagnetic material, or an alloy having superparamagnetic characteristics.

The electrodes may be comprised of a first electrode applying a magnetic field in a first direction and a second electrode applying a magnetic field in a second direction perpendicular to the first direction.

The electrodes may be grid-wire type electrodes or planar type electrodes.

A light-transmitting insulating material may be inserted between wires of the grid-wire type electrodes.

According to another aspect of the present invention, there is provided a magnetic display pixel comprising: a magnetic material layer in which magnetic moments are arranged in one direction when a magnetic field is applied; a first electrode and a second electrode for applying magnetic fields in two different directions to the magnetic material layer; a common electrode that is electrically connected to the first electrode and the second electrode; and a control circuit that switches a current flow between the first electrode and the common electrode and between the second electrode and the common electrode, wherein the arrangement direction of the magnetic moments of the magnetic material layer is varied by varying the intensity of the magnetic fields applied in the two different directions by the first electrode and the second electrode, respectively.

The control circuit may include at least one thin film transistor (TFT).

The magnetic display pixel may further comprise a first conductive spacer electrically connecting the first electrode and the common electrode and a second conductive spacer electrically connecting the second electrode and the common electrode, which are formed at a side of the magnetic material layer.

The common electrode may be a planar sheet or a wire in a grid structure that is electrically connected to the first and second conductive spacers.

Also, a light-transmitting insulating material may be inserted between wires of the grid-type common electrode.

According to the present invention, the common electrodes may be formed on the same plane as the first electrode and the second electrode in the form of wires to be connected to each other.

The common electrode may be formed of a first common electrode that is electrically connected to the first electrode and a second common electrode that is electrically connected to the second electrode.

According to the present invention, the length between the first common electrode and the control circuit and the length between the second common electrode and the control circuit may be the same.

The first and second electrodes may comprise at least one of In, Au, Sn, Pt, Pd, Al, Cu, Ag, Mg, Zn, Sc, Hf, Zr, Te, Se, Ta, W, Nb, Si, Ni, Co, Mo, Cr, Mn, Hg, Pr, La based elements, and iodine-doped polyacetylene elements.

The magnetic display pixel may further comprise an external polarizing plate formed at a side of the magnetic display pixel.

The external polarizing plate may be one of an absorptive polarizing plate, a wire grid reflection polarizing plate, and an active reflective polarizing plate having a magnetic material layer in which magnetic moments are arranged in one direction when magnetic field is applied.

When the external polarizing plate is an active reflective polarizing plate, and when the magnetization direction of the magnetic material layer of the external polarizing plate and the magnetization direction of the magnetic material layer of the magnetic display pixel are parallel to each other, a portion of incident light is transmitted, and when the above magnetization directions are perpendicular to each other, incident light cannot transmit.

Also, when the external polarizing plate is a wire grid reflection polarizing plate, and when the magnetization direction of the magnetic material layer of the magnetic display pixel and the arrangement direction of the wire grids are perpendicular to each other, a portion of incident light is transmitted, and when the directions are parallel to each other, incident light cannot transmit.

Also, when the external polarizing plate is an absorptive polarizing plate, and when the magnetization direction of the magnetic material layer of the magnetic display pixel and the polarization axis of the absorptive polarizing plate are perpendicular to each other, a portion of incident light is transmitted, and when the magnetization direction and the polarization axis are parallel to each other, light cannot transmit.

The magnetic display pixel may further comprise a first transparent substrate and a second transparent substrate that are respectively arranged on a rear surface and a front surface of the magnetic display pixel.

The magnetic display pixel may further comprise a color filter between the magnetic material layer and the second transparent substrate.

The magnetic display pixel may further comprise an absorptive polarizer on at least one of optical surfaces from the magnetic material layer to the second transparent substrate.

The magnetic display pixel may further comprise an anti-reflective coating on at least one of optical surfaces from the magnetic material layer to the second transparent substrate.

The magnetic display pixel may further comprise a black matrix that is formed at a side of the second transparent substrate, facing the control circuit.

According to another aspect of the present invention, there is provided a magnetic display panel including a plurality of magnetic display pixels having the above-described structure.

The magnetic display pixels may be arranged two-dimensionally between first and second transparent substrates that are common to the magnetic display pixels, each of the magnetic display pixels forming a sub-pixel.

The sub-pixels may respectively comprise a color filter, and the sub-pixels may form a pixel.

According to the present invention, the magnetic display pixels may comprise a common first electrode, a second electrode, and a common electrode, and a magnetic material layer and the first and second electrodes for applying magnetic fields in two different directions to the magnetic material layer may be included in each of the magnetic display pixels.

The common electrode may be formed planar on the magnetic material layer, or as wire-type electrodes between the lines and rows of the magnetic display pixels that are two-dimensionally arranged.

The magnetic display panel may be a flexible display panel formed of the first transparent substrate, the second transparent substrate, the first electrode, the second electrode, and the common electrode, which are formed of a flexible material.

The first and second transparent substrates may be formed of a light-transmitting resin material, and the first, second and common electrodes may be formed of a conductive polymer material.

The magnetic display panel may comprises a display unit in which a plurality of magnetic display pixels are arranged and a separate controlling unit that individually switches the current flow between the first electrode, the second electrode, and the common electrode with respect to each of the magnetic display pixels.

According to another aspect of the present invention, there is provided a double-sided display panel comprising: a backlight unit; and first and second magnetic display panel disposed symmetrically on both sides of the backlight unit, and including a plurality of display pixels having the above-described magnetic display pixels.

An electronic device according to another aspect of the present invention may employ the above-described magnetic display panel as an image display unit.

### BRIEF DESCRIPTION OF THE DRAWINGS

The above and other features of the present invention will become more apparent by describing in detail exemplary embodiments thereof with reference to the attached drawings in which:

FIG. 1 is a schematic view of an active reflective polarizer according to an exemplary embodiment of the present invention;

FIG. 2 illustrates the active reflective polarizer of FIG. 1 whose electrodes are planar;

FIGS. 3A through 3C illustrate the operation principle of the active reflective polarizer according to an exemplary embodiment of the present invention;

FIG. 4 is a schematic view of a magnetic material layer of the active reflective polarizer of FIG. 1;

FIG. 5 is a cross-sectional view of the magnetic material layer illustrated in FIG. 4;

FIG. 6 illustrates a structure of magnetic particles used in the magnetic material layer illustrated in FIG. 4;

FIGS. 7 and 8 illustrate another structure of the magnetic material layer;

FIG. 9 illustrates the arrangement of magnetic moments in the magnetic material layer when no magnetic field is applied;

FIGS. 10 and 11 are graphs illustrating transmission of a magnetic field in the magnetic material layer;

FIG. 12 is a graph illustrating a ratio of transmittance of perpendicular light to transmittance of parallel light in the magnetic material layer;

FIG. 13 is a cross-sectional view of a sub-pixel of a magnetic display panel according to another exemplary embodiment of the present invention;

FIG. 14 is a plan view of a sub-pixel of the magnetic display panel illustrated in FIG. 13;

FIG. 15 is an extended cross-sectional view of a sub-pixel of a magnetic display panel according to another exemplary embodiment of the present invention;

FIG. 16 is a schematic view of a magnetic display panel in which the sub-pixels of the magnetic display panel illustrated in FIG. 15 are arranged;

FIG. 17 is a cross-sectional view schematically illustrating a sub-pixel including a polarizing plate on an external surface of a magnetic display pixel of a magnetic display panel according to another embodiment of the present invention;

FIGS. 18A through 18C illustrate the operation principle of the magnetic display sub-pixel of the magnetic display panel of FIG. 17;

FIG. 19 is a graph illustrating the intensity of reflection and transmittance of light in the form of a cosine function of the magnetic display sub-pixel according to the operation principle illustrated in FIGS. 18A through 18C;

FIG. 20 illustrates the magnetic display pixel illustrated in FIG. 17 when it is turned off;

FIG. 21 illustrates the magnetic display pixel illustrated in FIG. 17 when it is turned on;

FIG. 22 is a cross-sectional view of a double-sided display panel using the structure of the sub-pixel of the magnetic display panel illustrated in FIG. 17;

FIG. 23 is a cross-sectional view illustrating another operation of the double-sided display panel illustrated in FIG. 22;

FIG. 24 is a cross-sectional view of a sub-pixel of a flexible magnetic display panel according to another embodiment of the present invention; and

FIG. 25 is a schematic view of a flexible display device in which the connection between a controlling unit and a display unit is schematically illustrated.

### DETAILED DESCRIPTION OF THE INVENTION

The present invention will now be described more fully with reference to the accompanying drawings, in which exemplary embodiments of the invention are shown.

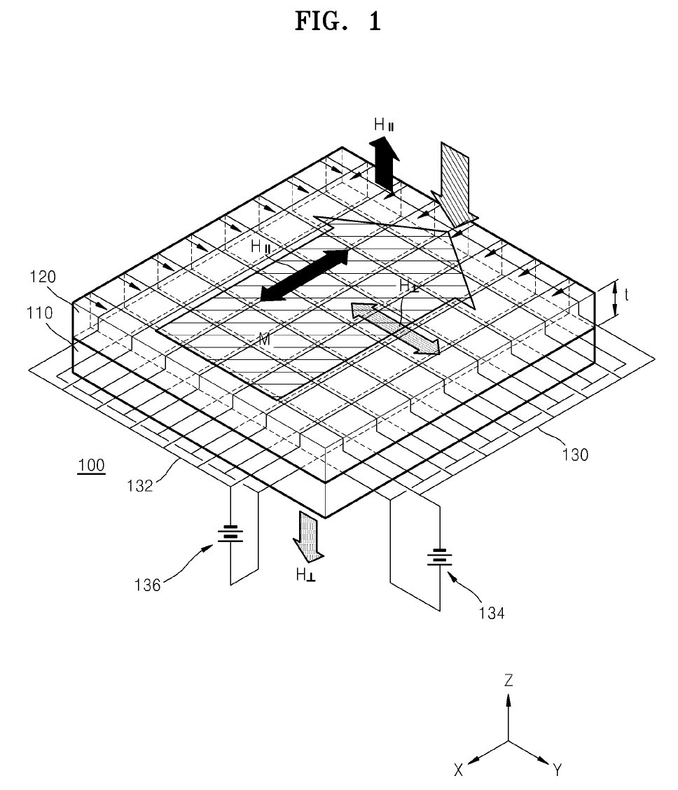

FIG. 1 is a cross-sectional view of an active reflective polarizer 100 according to an embodiment of the present invention. Referring to FIG. 1, the active reflective polarizer 100 includes a magnetic material layer 120 formed on a transparent substrate 110, and a first electrode 130 and a second electrode 132 for applying magnetic fields in two different directions to the magnetic material layer 120. As illustrated in FIG. 1, the first and second electrodes 130 and 132 for applying magnetic fields around the magnetic material layer 120 may be formed in a grid pattern. The first and second electrodes 130 and 132 may preferably be formed of a transparent conductive material such as Indium Tin Oxide (ITO), or may also be formed of opaque metal or other material. In FIG. 1, the first and second electrodes 130 and 132 are illustrated as surrounding the magnetic material layer 120 from above and below. Alternatively, the first and second electrodes 130 and 132 may also be formed in a grid pattern only on an upper surface of the magnetic material layer 120.

As illustrated in FIG. 1, the first electrode 130 for applying a magnetic field in a first direction (−x direction) is parallel to a y-direction, and the individual electrodes of the first electrode 130 are spaced apart in an x-direction at regular intervals. Also, the second electrode 132 for applying a magnetic field in a second direction (−y direction) is parallel to the x-direction and the individual electrodes of the second electrode 132 are spaced apart in a y-direction at regular intervals. A current is applied to the first and second electrodes 130 and 132, from a first power source 134 and a second power source 136, respectively. Here, the direction in which a magnetic field is applied can be varied according to the direction in which an electrode is formed. For example, when a current flows along the first electrode 130 in a y-direction on the magnetic material layer 120, as illustrated in FIG. 1, the magnetic material layer 120 is magnetized in the first direction, that is, the -x direction. On the other hand, when a current flows along the second electrode 132 in the x-direction on the magnetic material layer 120, the magnetic material layer 120 is magnetized in the second direction, that is, the y-direction.

Then, as illustrated in FIG. 1, a magnetic field H_{∥} having a component parallel to the magnetization direction of the magnetic material layer 120 is reflected, and a magnetic field H_{⊥} having a component perpendicular to the magnetization direction transmits through the magnetic material layer 120. This can be explained as follows. When light H_{∥} having a direction that is parallel to the arrangement of magnetic moments is incident on the magnetic material layer 120, an induced magnetic moment is generated. Accordingly, according to the principle of electromagnetic wave radiation, electromagnetic waves are generated by the induced magnetic moment that varies according to time. The electromagnetic waves can propagate in all directions. Thus when a thickness t of the magnetic material layer 120 is greater than a magnetic decay length, which is a similar concept to a skin depth of an electric field, the electromagnetic fields generated by the induced magnetic moments cannot be transmitted through the magnetic material layer 120. Accordingly, the magnetic field H_{∥} having a component parallel to the magnetization direction of the magnetic material layer is reflected.

On the other hand, when light H_{⊥} having a direction perpendicular to the arrangement of the magnetic moments is incident on the magnetic material layer 120, there is no interaction between the light H_{⊥} and magnetic moments, and no induced magnetic moments which vary according to time, occur. As a result, in the case of the perpendicular light H_{⊥}, it is as though the magnetic material layer 120 does not exist. Then the perpendicular light H_{⊥} can be transmitted through the active reflective polarizer 100 without being reflected. This will be further described with reference to a description about the magnetic material layer 120 which will be given later.

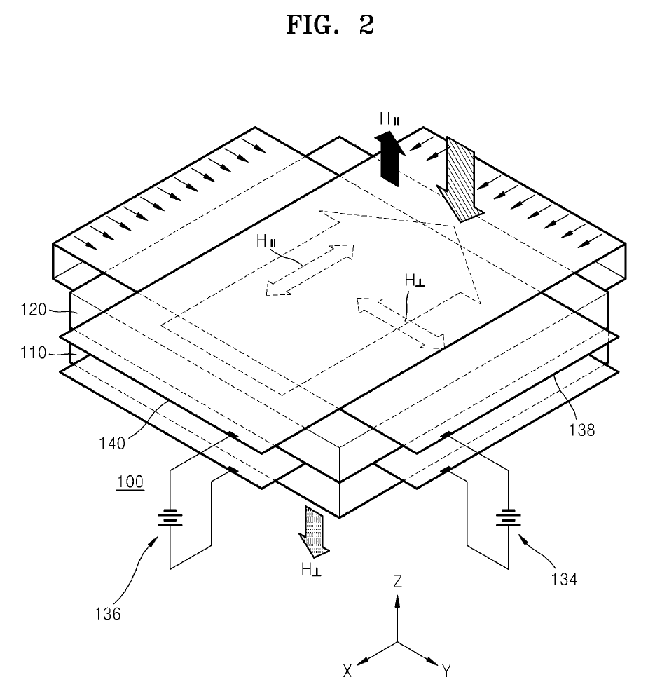

In FIG. 1, the first and second electrodes 130 and 132 are formed of a plurality of wires in order to apply a magnetic field above or around the magnetic material layer 120. However, planar transparent electrodes 138 and 140 formed around the magnetic material layer 120 as illustrated in FIG. 2 may also be used to apply a magnetic field. The planar transparent electrodes 138 and 140 may preferably be formed of a transparent conductive material. In this case, magnetic moments in the magnetic material layer 120 can be controlled by using a smaller current than when using the wire-type first and second electrodes 130 and 132 and the arrangement of the magnetic moments may be more uniform.

Also, in FIG. 2, the planar transparent electrodes 138 and 140 are illustrated as entirely surrounding the magnetic material layer 120. However, the planar transparent electrodes 138 and 140 may also be arranged only on an upper surface of the magnetic material layer 120. That is, the planar transparent electrodes 138 and 140 may be arranged only on an upper surface of the magnetic material layer 120, only on a lower surface of the magnetic material layer 120 or entirely around the magnetic material layer 120.

Also, in FIG. 2, like in FIG. 1, the planar transparent electrodes 138 and 140 are arranged so as to apply magnetic fields in two directions. As illustrated in FIG. 2, the first planar electrode 138, which is for applying a magnetic field in a first direction, is arranged so as to apply a current in a y-direction, and a second planar electrode 140, which is for applying a magnetic field in a second direction, is arranged so as to apply a current in an x-direction. The direction in which a magnetic field is applied can be varied according to the current direction. For example, when a current flows in a y-direction on the magnetic material layer 120, as illustrated in FIG. 2, the magnetic moments are arranged in a first direction, that is, −x direction, in the magnetic material layer 120. On the other hand, when a current flows in an x-direction on the magnetic material layer 120, the magnetic moments are arranged in a second direction, that is, a y-direction, in the magnetic material layer 120.

Meanwhile, as illustrated in FIG. 1, the first and second electrodes 130 and 132 are formed of grids in the active reflective polarizer 100 so as to apply magnetic fields in two directions. Thus according to the above described principle, a polarization component of light being transmitted through the magnetic material layer 120 can be selected according to the arrangement direction of the magnetic moments. That is, the polarization component of light is selected according to the direction of the magnetic field applied to the magnetic material layer 120 so as to transmit or reflect the light.

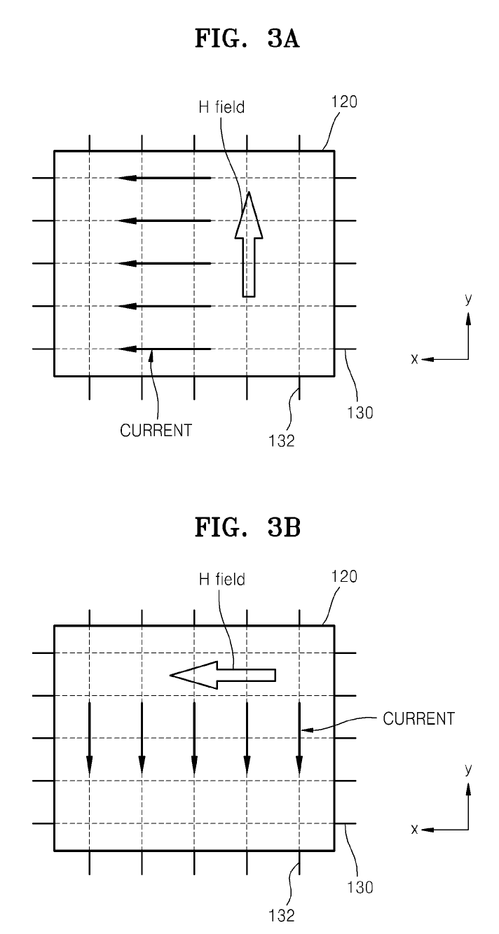

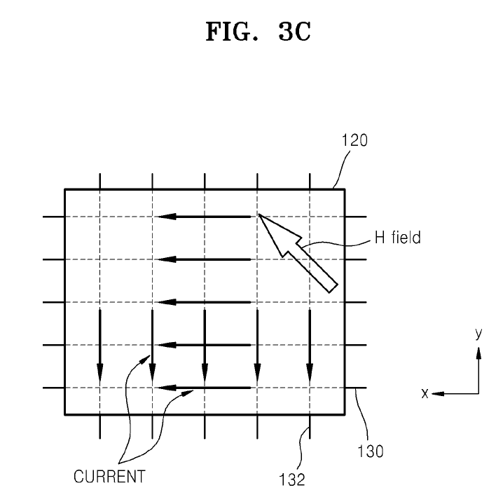

FIGS. 3A through 3C illustrate the operation principle of the active reflective polarizer 100 in which the wire-type first and second electrodes 130 and 132 are arranged in a grid pattern under the magnetic material layer 120. Referring to FIGS. 3A through 3C, the direction of a magnetic field (H field), that is, the arrangement direction of magnetic moments of the magnetic material layer 120, is changed according to the direction a current is applied to the magnetic material layer 120 and the intensity of the current. As illustrated in FIGS. 3A through 3C, the direction of the magnetic moments of the magnetic material layer 120 can be controlled within the range of 90 degrees, between the y-axis and the x-axis.

For example, when a current flows in an x-direction through the first electrode 130 that is parallel to the x-direction and no current flows through the second electrode 132 that is parallel to the y-direction, as illustrated in FIG. 3A, a magnetic field is induced in the magnetic material layer 120 in a y-direction. FIG. 3B illustrates a case in which when no current flows through the first electrode 130 and a current flows through the second electrode 132 in a y-direction, a magnetic field induced in the magnetic material layer 120 is in an x-direction. Also, as illustrated in FIG. 3C, when the same amount of current flows through the first electrode 130 and the second electrode 132, a magnetic field induced in the magnetic material layer 120 is centered between the x-direction and the y-direction, i.e., in a diagonal direction between the x and the y directions. Thus, the active reflective polarizer 100 can change the direction of the induced magnetic field between the y-direction to the x-direction by varying the amount of current flowing through the first electrode 130 and the second electrode 132. For example, when current flows through both the first and the second electrodes 130 and 132, increasing the current intensity in the second electrode 132 in the y-direction will change the direction of the induced magnetic field so that the angle between the direction of the induced magnetic field and the x-axis, is reduced. Accordingly, the polarization component and amount of light being transmitted through the active reflective polarizer 100 can be easily selected and controlled.

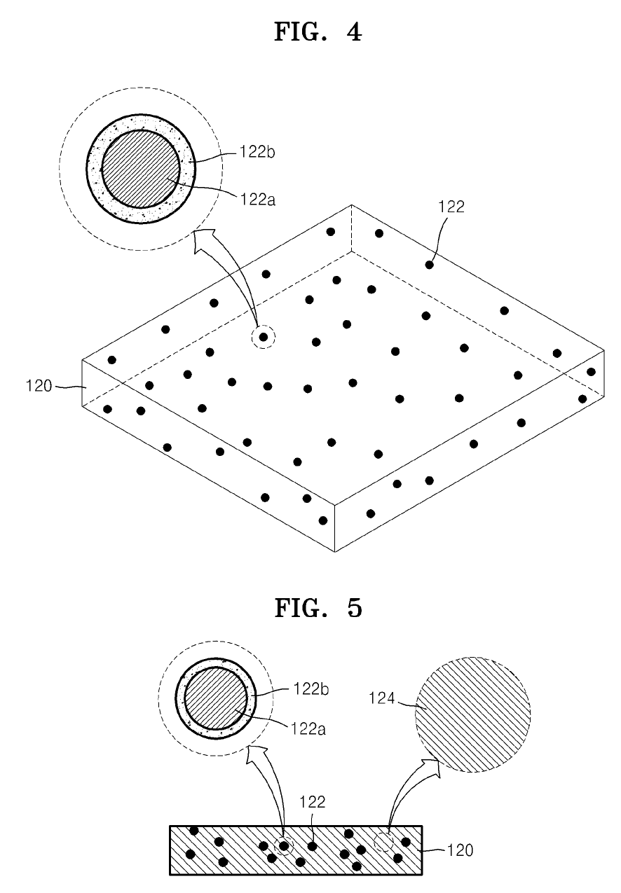

Meanwhile, FIG. 4 is a schematic view of a magnetic material layer 120, and FIG. 5 is a cross-sectional view of the magnetic material layer 120. Referring to FIGS. 4 and 5, the magnetic material layer may have a structure in which a plurality of magnetic particles 122 formed of magnetic cores are buried in a transparent insulating medium 124 without agglomeration or electrically contacting each other. In FIGS. 4 and 5, the magnetic particles 122 in the magnetic material layer 120 are illustrated as being sparsely distributed in the magnetic material layer 120 for convenience in illustration. In an exemplary embodiment, the magnetic particles 122 are filled very densely in the magnetic material layer 120. So that the magnetic particles 122 formed of magnetic cores do not agglomerate together or electrically contact each other, the magnetic particles 122 may be formed of magnetic cores 122a having conductivity, and transparent non-magnetic insulating shells 122b surrounding the magnetic cores 122a. Also, the area between the magnetic particles 122 may be filled with transparent insulating dielectric non-magnetic material like the insulating shells 122b.

The magnetic material layer 120 can be formed by mixing magnetic cores 122a having conductivity in a transparent insulating material in the form of a paste and then thinly coating on the transparent substrate 110 and curing the resultant product. Alternatively, the magnetic material layer 120 can be formed by immersing the magnetic particles 122 in core-shell structures in a solution and then spin coating or deep coating on the transparent substrate 110, and finally curing the resultant product. Recently, a conductive magnetic polymer film having the characteristics of magnetic bodies has been developed and provided for sale, and thus a magnetic material layer 120 can be formed by directly attaching a conductive magnetic polymer film on a transparent substrate 1 10. Also, the magnetic material layer 120 can be formed by mixing magnetic cores, and insulating transparent non-magnetic cores and then immersing the mixed cores in one solution, and then spin coating or deep coating on the transparent substrate 110, and finally curing the resultant product. Other methods can also be used to form the magnetic material layer 120 as long as the magnetic particles 122 do not agglomerate together or electrically contact each other in the magnetic material layer 120.

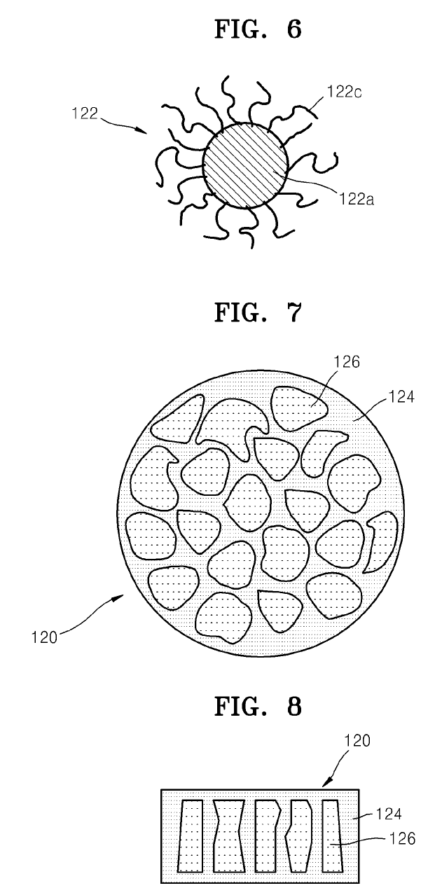

FIG. 6 illustrates another example of a magnetic particle 122 having a core-shell structure forming a magnetic material layer 120. As illustrated in FIG. 6, the magnetic particle 122 may be formed of a core 122a formed of a magnetic body and an insulating shell 122c surrounding the core 122a. The insulating shell 122c may be formed of an insulating surfactant in the form of a polymer surrounding the core 122a.

The core 122a of the magnetic particles 122 can be formed of a material that has great conductivity and magnetic susceptibility. The material having great conductivity and magnetic susceptibility may be, for example, one of a ferromagnetic material, a paramagnetic material, a superparamagnetic material, and an alloy having superparamagnetic characteristics. When one of the paramagnetic body, the superparamagnetic body, and the alloy having superparamagnetic characteristics is used to realize the active reflective polarizer 100, a current should be continuously applied through the first electrode 130 and the second electrode 132 in order to control the transmission amount of light while smoothly controlling the arrangement of the magnetic moments of the magnetic material layer 120.

On the other hand, when a ferromagnetic body is used as the material of the magnetic material layer 120 of the active reflective polarizer 100, there is no need to continually apply current through the surface of the magnetic material layer 120 in order to control the amount of light transmitted while smoothly controlling the arrangement of the magnetic moments of the magnetic material layer 120. Once the magnetic moments of a ferromagnetic body are arranged by a magnetic field, the ferromagnetic body maintains the arrangement. Thus when a ferromagnetic body is used as the magnetic material layer 120, a current needs to be applied through the surface of the magnetic material layer 120 for a moment until magnetic moments are arranged and then the current can be turned off.

For example, the magnetic cores 122a can be formed of a paramagnetic metal or alloy such as titanium, aluminum, barium, platinum, natrium, strontium, magnesium, dysprosium, manganese, or gadolinium; or a non-magnetic material such as silver or copper; or an antiferromagnetic metal that changes into a paramagnetic body at a Néel temperature or greater, such as chromium. In addition, the magnetic cores 122a may be formed of a ferromagnetic metal such as cobalt, iron, nickel or an alloy including the same that is made to have superparamagnetic characteristics. For a ferromagnetic body to have superparamagnetic characteristics, the volume of a magnetic core should be smaller than a single magnetic domain. Besides, if a dielectric material, a semiconductor, or a polymer, etc. have magnetic characteristics, the magnetic cores 122a may be formed of these materials. Also, a ferrimagnetic substance which has relatively low conductivity but great magnetic susceptibility can be used. Examples of the ferromagnetic substance include iron oxides such as MnZn(Fe₂O₄)₂, MnFe₂O₄, Fe₃O4, Fe₂O₃, or Sr₈CaRe₃Cu₄O₂₄.

The diameter of the magnetic core 122a should be small enough to form a single magnetic domain. Accordingly, the diameter of the core 122a of the magnetic particle 122 may be in the range of several to several tens of nm. For example, the diameter of the core 122a may be 1 nm to 200 nm, depending on the material.

Meanwhile, the function of the shells 122b and 122c is to prevent adjacent cores 122a from agglomerating or contacting each other directly so as to prevent electrical contact between the cores 122a. To this end, as illustrated in FIGS. 4 and 5, a shell 122b formed of a transparent insulating dielectric non-magnetic material such as SiO₂ or ZrO₂ can surround the core 122a. Also, as illustrated in FIG. 6, a shell 122c formed of a surfactant in the form of a polymer may surround the core 122a. The polymer-shaped surfactant should be transparent, insulating, and non-magnetic. The thickness of the shells 122b and 122c is sufficient enough when the adjacent cores 122a do not conduct electricity to each other.

FIGS. 7 and 8 illustrate another structure of a magnetic material layer 120; FIG. 7 illustrates a horizontal cross-section of the magnetic material layer 120, and FIG. 8 illustrates a vertical cross-section of the magnetic material layer 120. The magnetic material layer 120 illustrated in FIGS. 7 and 8 has a structure in which cylindrical magnetic particles 126 are stuck in a transparent insulating medium 124 such as SiO₂ instead of a core-shell structure. Also in this case, each of the magnetic particles 126 is of a size suitable to form a single magnetic domain, and may be formed of one of the above-described magnetic materials. Such a structure can be formed by forming a dielectric body template having minute pores using an anodic oxidation method and filling the pores with a magnetic material by using, for example, a sputtering method.

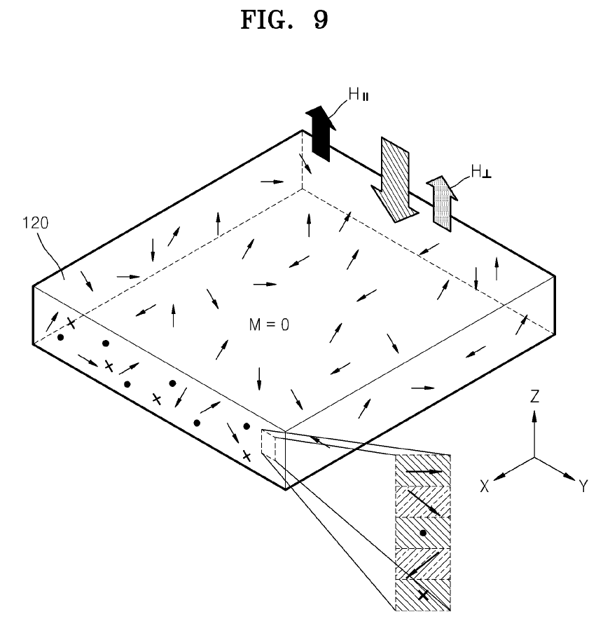

FIG. 9 illustrates the arrangement of magnetic moments in the magnetic material layer 120 when no magnetic field is applied. When no magnetic field is applied, the overall magnetic moments in the magnetic material layer 120 are arranged randomly in various directions as shown by arrows in FIG. 9. In FIG. 9, ‘·’ denotes magnetic moments in the +x direction on an x-y plane, and ‘x’ denotes magnetic moments in the [symbol] direction on an x-y plane. Also, as shown in FIG. 9, the magnetic moments in the magnetic material layer 120 are arranged randomly not only on the x-y plane but also in a vertical direction, that is, the −z direction. Accordingly, when no magnetic field is applied, the total magnetization of the magnetic material layer 120 is 0 (M=0).

Hereinafter, the principle of light being transmitted/blocked in the magnetic material layer 120 will be described.

A magnetic field of electromagnetic waves that are incident on the magnetic material layer 120 can be divided into a component H_{⊥} perpendicular and a component H parallel to the magnetization direction of the magnetic material layer 120. When the component H that is parallel to the magnetization direction is incident on the magnetic material layer 120, induced magnetic moments occur in interaction with the magnetic moments arranged in the magnetization direction. The magnetic moments induced in this manner vary with time as the amplitude of a magnetic field of the component H varies with time. As a result, according to the principle of electromagnetic wave radiation, electromagnetic waves occur by the time-varying induced magnetic moments. The electromagnetic waves can spread out in all directions. However, electromagnetic waves traveling into the magnetic material layer 120, that is, electromagnetic waves traveling in the −z direction, decay due to the magnetic material layer 120. When a thickness t of the magnetic material layer 120 is greater than a magnetic decay length, which is similar to a skin depth length of the electromagnetic field, most electromagnetic waves traveling into the magnetic material layer 120 generated by the induced magnetic moment decay, and only electromagnetic waves traveling in the +z direction, remain. Accordingly, a component H to the magnetization direction can be regarded as being reflected by the magnetic material layer 120.

On the other hand, when a component H_{⊥} perpendicular to the magnetization direction is incident on the magnetic material layer 120, the component H_{⊥} does not interact with magnetic moments, and thus no induced magnetic moments occur. As a result, the component H_{⊥} perpendicular to the magnetization direction is transmitted through the magnetic material layer 120 without decay.

Consequently, in the magnetic field of the electromagnetic waves that are incident on the magnetic material layer 120, the component H_{∥} parallel to the magnetization direction is reflected by the magnetic material layer 120, and the component H_{⊥} perpendicular to the magnetization direction is transmitted through the magnetic material layer 120. Accordingly, light energy (S_{∥}=E_{|}×H_{∥}) related to the magnetic field of the component H_{∥} parallel to the magnetization direction is reflected by the magnetic material layer 120, and light energy (S_{⊥}=E_{⊥}×H_{⊥}) related to the magnetic field of the component H_{⊥} is transmitted through the magnetic material layer 120.

When no magnetic field is applied to the magnetic material layer 120 as illustrated in FIG. 9, the magnetic moments in the magnetic material layer 120 are arranged randomly not only on the x-y plane but also in the depth direction, that is, the −z direction. Accordingly, light that is incident on the magnetic material layer 120 to which no magnetic field is applied is completely reflected. On the other hand, when a magnetic field is applied to the magnetic material layer 120, the magnetic moments in the magnetic material layer 120 are arranged in one direction. Among the light incident on the magnetic material layer 120, light having a polarization component related to the parallel magnetic field to the magnetization direction is reflected by the magnetic material layer 120, and light having a polarization component corresponding to the magnetic field perpendicular to the magnetization direction is transmitted through the magnetic material layer 120. In this manner, the magnetic material layer 120 can function as an optical shutter that blocks light when no magnetic field is applied and transmits light when a magnetic field is applied.

Meanwhile, the magnetic material layer 120 should have a sufficient thickness to decay electromagnetic waves traveling into the magnetic material layer 120 to function as an optical shutter. That is, as described above, the thickness of the magnetic material layer 120 should be greater than the magnetic decay length of the magnetic material layer 120. In particular, when the magnetic material layer 120 is formed of magnetic cores dispersed in a transparent medium, a sufficient number of magnetic cores should be present in the magnetic material layer 120 along the path that the light travels. For example, if the magnetic material layer 120 is assumed to be formed by stacking identical layers on the x-y plane in which magnetic cores are uniformly distributed in a single layer, in a z-direction, the number n of magnetic cores needed along the path of light traveling in a [symbol] direction can be given as follows.

n≧s/d [EQN. 1]

Here, s is the magnetic decay length of the magnetic cores at the wavelength of incident light, and d is the diameter of the magnetic cores. For example, when the diameter of the magnetic cores is 7 nm and the magnetic decay length of the magnetic cores at the wavelength of incident light is 35 nm, five magnetic cores are required along the light path. Accordingly, when the magnetic material layer 120 is formed of magnetic cores dispersed in a transparent medium, the thickness of the magnetic material layer 120 can be decided, considering the density of the magnetic cores, so that n or more magnetic cores are present in the thickness direction of the magnetic material layer.

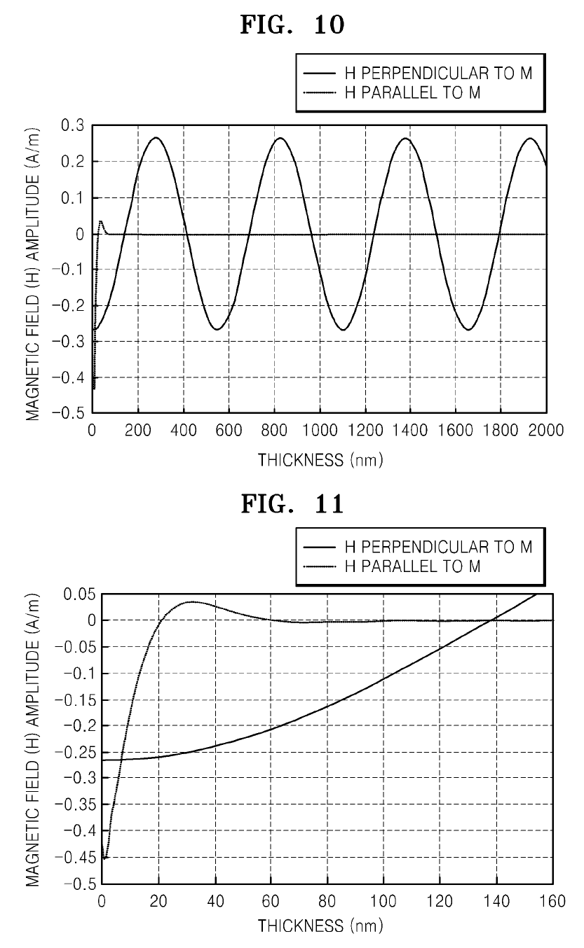

FIGS. 10 through 12 illustrate the simulation results for identifying the characteristics of the magnetic material layer 120.

First, FIG. 10 is a graph illustrating the intensity of a magnetic field (A/m) being transmitted through the magnetic material layer 120 when a magnetic field is applied, and FIG. 11 is a graph showing an expanded portion of FIG. 10. The graphs of FIGS. 10 and 11 are results with respect to the magnetic material layer 120 for which titanium is used as a magnetic body at the wavelength of incident light of 550 nm. As is well known, titanium has a magnetic susceptibility of about 18×10⁻⁵ at room temperature of 20° C. and electric conductivity of about 2.38×10⁶ S(Siemens). As illustrated in FIGS. 10 and 11, the magnetic field that is perpendicular to the magnetization direction of the magnetic material layer 120 transmits the magnetic material layer 120 without decay loss even when the thickness of the magnetic material layer 120 increases. On the other hand, the magnetic field parallel to the magnetization direction of the magnetic material layer 120 is greatly decayed and the amplitude thereof becomes almost 0 at the thickness of about 60 nm of the magnetic material layer 120. Thus when titanium is used as a magnetic material for the magnetic material layer 120, the thickness of the magnetic material layer 120 may be preferably about 60 nm or greater.

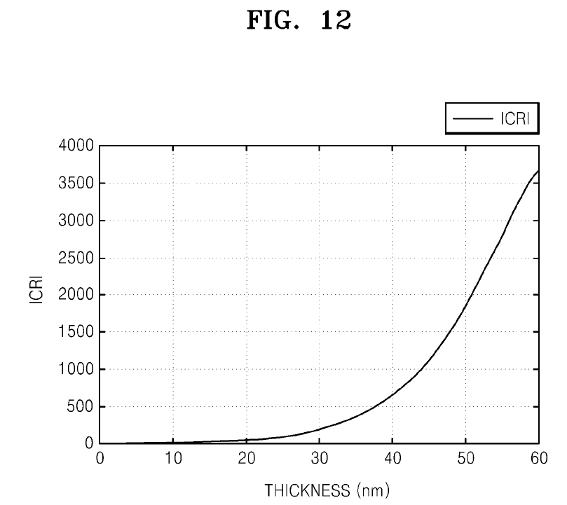

Also, FIG. 12 is a graph showing the absolute value of a contrast ratio (CR) of the magnetic material layer 120, that is, the ratio of the transmission of light having a parallel magnetic field to the magnetization direction to the transmission of light having a perpendicular magnetic field to the magnetization direction. For example, when WI is light to be transmitted and W2 is light not to be transmitted, the contrast ratio CR can be defined as W1/W2. In the case of the magnetic material layer 120, W1 is S_{⊥}=E_×H_{⊥}, and W2 is S_{∥}=E_{∥}×H_{∥}. The graph of FIG. 12 shows that the greater the thickness of the magnetic material layer 120 is, the greater the contrast ratio.

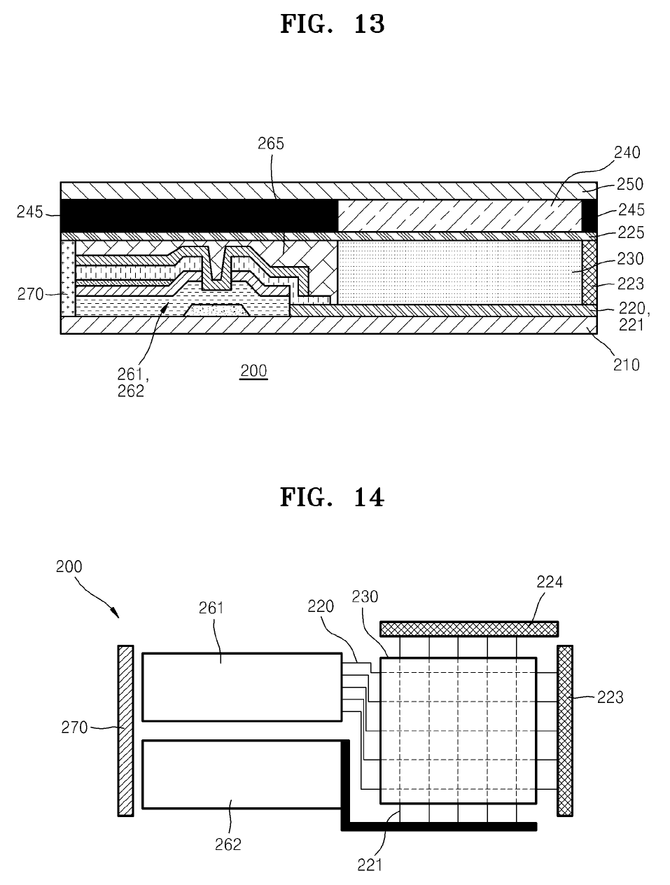

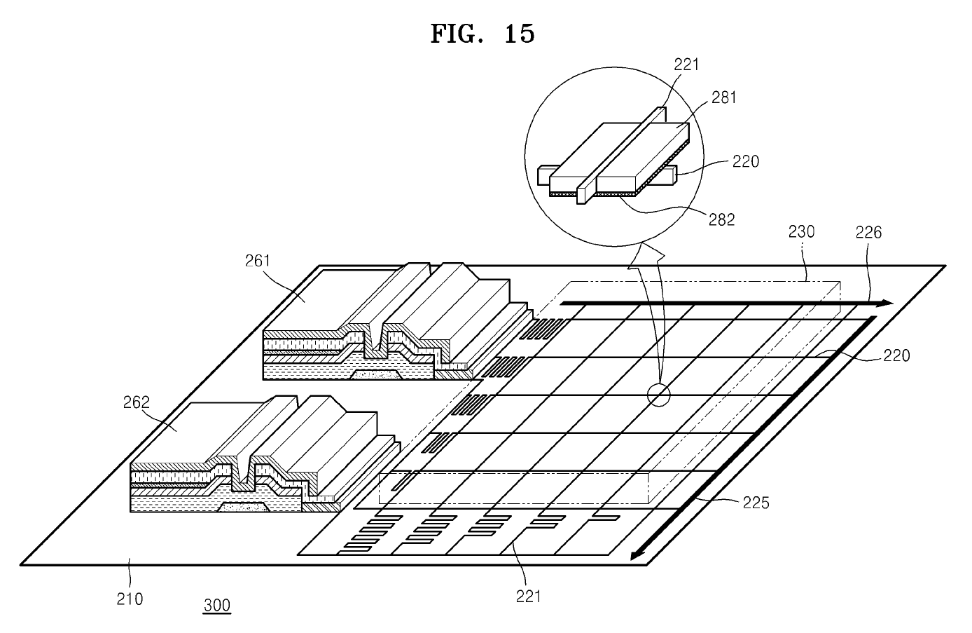

FIG. 13 is a cross-sectional view of a sub-pixel 200 of a magnetic display panel to which the principle of the above described active reflective polarizer 100 is applied according to an embodiment of the present invention, and FIG. 14 is a plan view of a sub-pixel 200 of the magnetic display panel. Referring to FIGS. 13 and 14, the sub-pixel 200 of the magnetic display panel includes a first transparent substrate 210, a magnetic material layer 230 formed on the first transparent substrate 210, first and second sub-pixel electrodes 220 and 221 arranged between the transparent substrate 210 and the magnetic material layer 230, a common electrode 225 arranged on the magnetic material layer 230, first and second conductive spacers 223 and 224 that are arranged at sides of the magnetic material layer 230, seal the magnetic material layer 230, and electrically connect the first and second sub-pixel electrodes 220 and 221 and the common electrode 225, a color filter 240 arranged on the common electrode 225, and a second transparent substrate 250 arranged on the color filter 240.

Here, one first transparent substrate 210 and one second transparent substrate 250 and the common electrode 225 can be commonly used for all sub-pixels 200 of the magnetic display panel according to the present invention. In FIG. 13, the common electrode 225 is illustrated as being arranged on the surface of the color filter 240 and the first and second sub-pixel electrodes 220 and 221 as being arranged on an inner surface of the first transparent substrate 210. However, the position of the first and second sub-pixel electrodes 220 and 221 and the common electrode 225 may be switched. Also, in the case of a black-and-white display device, the color filter 240 may be omitted.

As illustrated in FIG. 14, the first and second sub-pixel electrodes 220 and 221 can be formed of a plurality of wires crossing one another perpendicularly. Accordingly, like the active reflective polarizer 100, the first and second sub-pixel electrodes 220 and 221 can apply magnetic fields in two perpendicular directions to the magnetic material layer 230. According to the present invention, in order to switch the current flow between the first and second sub-pixel electrodes 220 and 221 and the common electrode 225, first and second control circuits 261 and 262 are arranged near the magnetic material layer 230. For example, the first and second control circuits 261 and 262 can also be used in a thin film transistor (TFT) that is usually used in a liquid crystal display panel. When the first control circuit 261 is turned on, a current flows between the first sub-pixel electrode 220 and the common electrode 225, and when the second control circuit 262 is turned on, a current flows between the second sub-pixel electrode 221 and the common electrode 225. Accordingly, an end of the first sub-pixel electrode 220 is connected to the first control circuit 261, and the other end is connected to the first conductive spacer 223. Also, an end of the second sub-pixel 221 is connected to the second control circuit 262, and the other end is connected to the second conductive spacer 224. The first and second conductive spacers 223 and 224 are connected to the common electrode 225.

Barrier ribs 270 may be formed between the common electrode 225 and the first transparent substrate 210 along the rim of the sub-pixel 200. The barrier ribs 270 completely seal the inner space between the first and second transparent substrates 210 and 250 together with the first and second conductive spacers 223 and 224. A black matrix 245 is formed in a space between the common electrode 225 and the second transparent substrate 250 facing the control circuits 261 and 262, the barrier ribs 270, and conductive spacers 223 and 224. The black matrix 245 ensures that the control circuits 261 and 262, the barrier ribs 270, and the conductive spacers 223 and 224 are not seen from the outside.

Also, although not illustrated in detail in FIG. 13, in order to prevent a dazzling effect due to reflection or diffusion of external light, an anti-reflective coating or absorptive polarizer can be formed on at least one of optical surfaces from the magnetic material layer 230 to the second transparent substrate 250. For example, an anti-reflection coating or absorptive polarizer can be formed between the magnetic material layer 230 and the common electrode 225, between the common electrode 225 and the color filter 240, between the color filter 240 and the second transparent substrate 250, or on the second transparent substrate 250.

When manufacturing the sub-pixel 200 of the magnetic display device according to the present invention, an insulating layer 265 can be formed to the same height as the magnetic material layer 230 on an area where the control circuits 261 and 262 are formed. Alternatively, the entire region of the sub-pixel 200 of the magnetic display device including the control circuits 261 and 262 may be covered with the magnetic material layer 230. Covering the entire substrate with a magnetic material using spin-coating or another method is a simple process.

The sub-pixel 200 of the magnetic display device according to the present invention can be operated even when the entire region is covered with the magnetic material layer 230 because magnetic moments are arranged only in a space where a magnetic field is applied. Other portions covered with the magnetic material layer 230, for example, the upper area of the control circuits 261 and 262 include almost no magnetic field, and thus these portions do not affect the operation of the sub-pixel 200 of the magnetic display device.

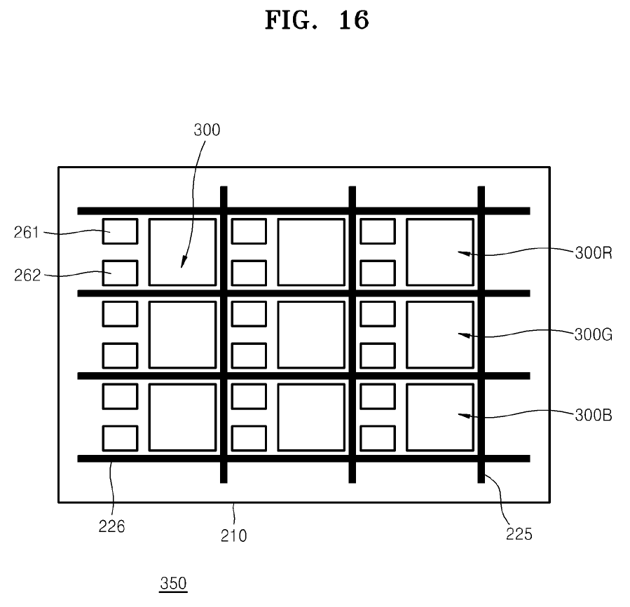

FIG. 15 illustrates a sub-pixel 300 according to another embodiment of the present invention, wherein two common electrodes 225 and 226 are formed as wires on the same plane. FIG. 16 illustrates a magnetic display panel 350 according to another embodiment of the present invention in which the sub-pixels 300 are arranged.

First, referring to FIG. 16, the magnetic display panel 350 includes a plurality of sub-pixels 300 arranged two-dimensionally on a common first transparent substrate 210, and one pixel may be formed of sub-pixels 300R, 300G, and 300B having different color filters. The color filter may be formed on a second transparent substrate to correspond to each of the sub-pixels 300. Also, as illustrated in FIG. 15, the magnetic material layer 230 and the first and second sub-pixels electrodes 220 and 221 for applying magnetic fields to the magnetic material layer 230 are respectively arranged in each of the magnetic display pixels in the sub-pixel 200 of the magnetic display sub-pixel 300.

FIG. 15 illustrates the magnetic material layer 230 formed on the first transparent substrate 210, the first and second sub-pixel electrodes 220 and 221, and the first and second control circuits 261 and 262 that are connected to the first and second common electrodes 225 and 226 extended in a three dimensional space. While one planar common electrode 225 is facing the first and second sub-pixel electrodes 220 and 221 around the magnetic material layer 230 in FIG. 13, the common electrodes 225 and 226 in the form of two wires are connected to each other on the same plane as the first and second sub-pixel electrodes 220 and 221 in FIG. 15. In detail, the first sub-pixel electrode 220 is connected to the first common electrode 225, and the second sub-pixel electrode 221 is connected to the second common electrode 226 on the same plane. Since the common electrodes 225 and 226 and the sub-pixel electrodes 220 and 221 are formed on the same plane in the magnetic display sub-pixel 300, the first conductive spacer 223 and the second conductive spacer 224 illustrated in FIG. 13 are not required.

Meanwhile, when the magnetic material layer 230 is interposed between the wires which form the first sub-pixel electrode 220 and the second sub-pixel electrode 221 illustrated in FIGS. 13 and 15, magnetic moments may not be arranged by an induced magnetic field in portions where the magnetic material layer 230 is interposed. This is because the magnetic fields are offset between the adjacent wires, and if the magnetic moments are not arranged, incident light cannot be transmitted and accordingly the display pixel cannot operate. Accordingly, in order to solve such a problem, a light-transmitting insulating material 281 is inserted between wires forming the sub-pixel electrodes 220 and 221 in order to planarize the light-transmitting insulating material 281 to the same height as or to a higher height than the wires of the sub-pixel electrodes 220 and 221. Also, the common electrodes 225 and 226 may be a planar type, parallel wires, or wire grid structures. In the case of the wires or grid structures, a light-transmitting insulating material may be inserted between wires forming the common electrodes 225 and 226 and planarize light-transmitting insulating material 281 to the same height or a higher height than the wires forming the common electrodes 225 and 226. Also, the crossing points of the first sub-pixel electrode 220 and the second sub-pixel electrode 221 should be spaced apart from each other in the magnetic display sub-pixels 200 and 300 illustrated in FIGS. 13 and 15, and this can be done by inserting a thin layer insulator 282 between the first sub-pixel electrode 220 and the second sub-pixel electrode 221.

Also, in FIG. 15, the length of the wires connected from the first common electrode 225 to the first control circuit 261 and the length of the wires connected from the second common electrode 226 to the second control circuit 262 are made to be the same so as to make the resistances of all the electrode wires the same. The purpose of making the resistances of each of the electrode wires the same, and accordingly making the current flowing through the electrode wires the same, is to apply a uniform magnetic field to the magnetic material layer 230.

The first sub-pixel electrode 220 and the second sub-pixel electrode 221 of FIG. 15 are illustrated as being wires; however, the first and second sub-pixel electrodes 220 and 221 may also be formed as planar conductive sheets. In this case, the conductive sheets should be able to transmit light, and thus may preferably be formed of a transparent conductive material such as ITO. Also, the first common electrode 225 and the first control circuit 261, or the second common electrode 226 and the second control circuit 262 may also be respectively connected by planar conductive sheets. The planar conductive sheet connecting between the first common electrode 225 and the first control circuit 261 and the planar conductive sheet connecting between the common electrode 226 may be preferably electrically separated from each other.

The above described sub-pixel electrodes 220 and 221, the common electrodes 225 and 226, and the conductive spacers 223 and 224 may be formed of one of transparent conductive materials, transparent conductive oxides, opaque metals, and opaque metal compounds including at least one selected from the group consisting of In, Au, Sn, Pt, Pd, Al, Cu, Ag, Mg, Zn, Sc, Hf, Zr, Te, Se, Ta, W, Nb, Si, Ni, Co, Mo, Cr, Mn, Hg, Pr, La based elements, and iodine-doped polyacetylene elements. Also, all of the above described sub-pixel electrodes 220 and 221 and the common electrodes 225 and 226 may be formed, for example, by using carbon nanotubes.

As described above, when paramagnetic or superparamagnetic material is used as the magnetic material layer 120 in the active reflective polarizer 100 according to the present invention, in order to maintain the arrangement direction of magnetic moments, that is, to maintain the amount of light transmitted, a current needs to be applied continuously. On the other hand, when a ferromagnetic material is used as the magnetic material layer 120, there is no need to continually apply current through the magnetic material layer 120 in a state where light should be transmitted. The magnetic moments of the ferromagnetic material maintains the arrangement once they are arranged by a magnetic field, even after the magnetic field is removed. Thus, when the ferromagnetic body is used as the magnetic material layer 120, a surface current needs to be applied for a moment until the magnetic moments of the magnetic material layer 120 are arranged and then the surface current turned off.

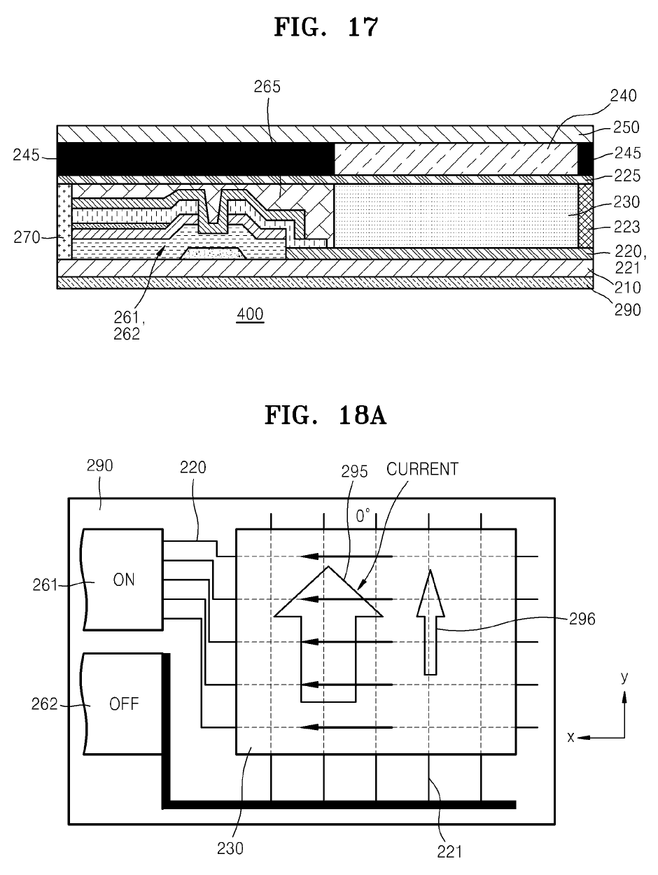

However, when the active reflective polarizer 100 is applied to the magnetic display pixel, a problem may occur when completely closing an optical valve. Accordingly, according to another embodiment of the present invention, a polarizing plate may further be formed on an external surface of the magnetic display sub-pixel 200 or 300 illustrated in FIGS. 13 and 15, respectively. FIG. 17 is a cross-sectional view of a sub-pixel 400 of a magnetic display panel according to another embodiment of the present invention, further including a polarizing plate on an external surface of the magnetic display sub-pixel 200 or 300.

As described above, when a paramagnetic or a superparamagnetic material is used as the magnetic material layer 230 of the magnetic display sub-pixel 400 of the present invention, a current should be applied continuously therethrough in order to maintain the direction of arrangement of the magnetic moments. This is because, if a magnetic field disappears, the arrangement of the magnetic moments of a paramagnetic substance or a superparamagnetic substance becomes random, and thus the magnetic material layer cannot transmit light. On the other hand, when a ferromagnetic material is used as the magnetic material layer 230, a surface current needs to be applied for a moment until the magnetic moments of the magnetic material layer 230 are arranged and then the surface current is turned off.

Referring to FIG. 17, the sub-pixel 400 of the magnetic display panel of the present invention includes a first transparent substrate 210, a magnetic material layer 230 formed on the first transparent substrate 210, sub-pixel electrodes 220 and 221 arranged between the first transparent substrate 210 and the magnetic material layer 230, a common electrode 225 arranged on the upper surface of the magnetic material layer 230, a conductive spacer 223 that is formed at a side of the magnetic material layer 230 and seals the magnetic material layer 230 and electrically connects the sub-pixel electrodes 220 and 221 and the common electrode 225, a color filter 240 arranged on the common electrode 225, a second transparent substrate 250 formed on the color filter 240, and an external polarizing plate 290 formed under the first transparent substrate 210. Here, one first transparent substrate 210 and one second transparent substrate 250 and the common electrode 225 are commonly used for all of the sub-pixels 400 of the magnetic display panel according to the present invention. In FIG. 17, the common electrode 225 is illustrated as being arranged on the surface of the color filter 240 and the sub-pixels 220 and 221 are illustrated as being arranged inside the first transparent substrate 210. However, the position of the sub-pixel electrodes 220 and 221 and the common electrode 225 may be switched. Also, in the case of a black-and-white display device, the color filter 240 may be omitted.

Although not illustrated in FIG. 17, as illustrated in FIGS. 13 and 15, the sub-pixel electrode is formed of wire-type first and second sub-pixel electrodes 220 and 221, and a light-transmitting insulator is filled between the wires. The conductive spacer is also formed of a first conductive spacer 223 that is connected to the first sub-pixel electrode 220 and a second conductive spacer 224 that is connected to the second sub-pixel electrode 221 (see FIG. 14). When the common electrode is formed of wires as illustrated in FIG. 15, the conductive spacer can be omitted. In this case, the common electrode is formed of a first common electrode 225 that is connected to the first sub-pixel electrode 220 and a second common electrode 226 that is connected to the second sub-pixel electrode 221 (see FIG. 15).

In addition, in order to switch the current flow between the first and second sub-pixel electrodes 220 and 221 and the common electrode 225, first and second control circuits 261 and 262 are arranged so as to be adjacent to the magnetic material layer 230. For example, the first and second control circuits 261 and 262 may include at least one thin film transistor (TFT) that is usually used for a liquid crystal display panel.

Barrier ribs 270 are formed along the circumference of the sub-pixel 400, and the function of the barrier ribs 270 is to completely seal the inner space between the first and second transparent substrates 210 and 250 together with the first and second conductive spacers 223 and 224. A black matrix 245 is formed under the second transparent substrate 250 facing the control circuits 261 and 262, the barrier ribs 270, and the conductive spacers 223 and 224. The black matrix 245 ensures that the control circuits 261 and 262, the barrier ribs 270, and the conductive spacers 223 and 224 are not seen from the outside.

Although not illustrated in FIG. 17, as in FIG. 13, in order to prevent a dazzling effect due to reflection and diffusion of external light, an anti-reflection coating or absorptive polarizer can be formed on at least one optical surface from the magnetic material layer 230 to the second transparent substrate 250. For example, an anti-reflection coating or absorptive polarizer may be arranged between the magnetic material layer 230 and the common electrode 225, between the common electrode 225 and the color filter 240, between the color filter 240 and the second transparent substrate 250, or on the upper surface of the second transparent substrate 250.

When manufacturing the magnetic display sub-pixel 200 according to the present invention, an insulating layer 265 can be formed to the same height as the magnetic material layer 230 on an area where the control circuits 261 and 262 are formed. Alternatively, the entire region of the sub-pixel 200 of the magnetic display device including the control circuits 261 and 262 may be covered with the magnetic material layer 230. Covering the entire substrate with a magnetic material is a simple process using spin-coating or another method.

The sub-pixel 200 of the magnetic display device according to the present invention can be operated even when the entire region is covered with the magnetic material layer 230 because magnetic moments are arranged only in a space where a magnetic field is applied. Other portions covered with the magnetic material layer 230, for example, the upper area of the control circuits 261 and 262, include almost no magnetic field, and thus these portions do not affect the operation of the magnetic display sub-pixel 200.

In short, one sub-pixel 400 of the magnetic display panel illustrated in FIG. 17 includes an external polarizing plate 290 under the first transparent substrate 210 in addition to the sub-pixels 200 and 300 illustrated in FIGS. 13 and 15. The rest of the structure is the same as in the other embodiments described above. In FIG. 17, the external polarizing plate 290 is illustrated as being disposed under the first transparent substrate 210. However, the external polarizing plate 290 may also be disposed on the second transparent substrate 250.

The external polarizing plate 290 may be one of an absorptive polarizing plate, a reflective polarizing plate, and an active reflective polarizing plate. When the external polarizing plate 290 is an active reflective polarizing plate, some of the polarization components of incident light are transmitted when the arrangement of the magnetic moments of the external polarizing plate 290 and the arrangement of the magnetic material layer 230 in one sub-pixel 400 of the magnetic display panel are parallel to each other, and when the arrangements are perpendicular to each other, incident light cannot be transmitted. On the other hand, when the external polarizing plate 290 is a wire grid reflection polarizing plate, some of the polarization components of incident light are transmitted when the arrangement of magnetic moments of the magnetic material layer 230 in one sub-pixel 400 of the magnetic display panel and the arrangement of the wire grid are perpendicular to each other, and when the arrangements are parallel to each other, incident light cannot be transmitted. Also, when the external polarizing plate 290 is an absorptive polarizing plate, some of the polarization components of incident light are transmitted when the arrangement of magnetic moments of the magnetic material layer 230 in one sub-pixel 400 of the magnetic display panel and the polarization axis of the absorptive polarizing plate are perpendicular to each other, and when the arrangements are parallel to each other, incident light cannot be transmitted.

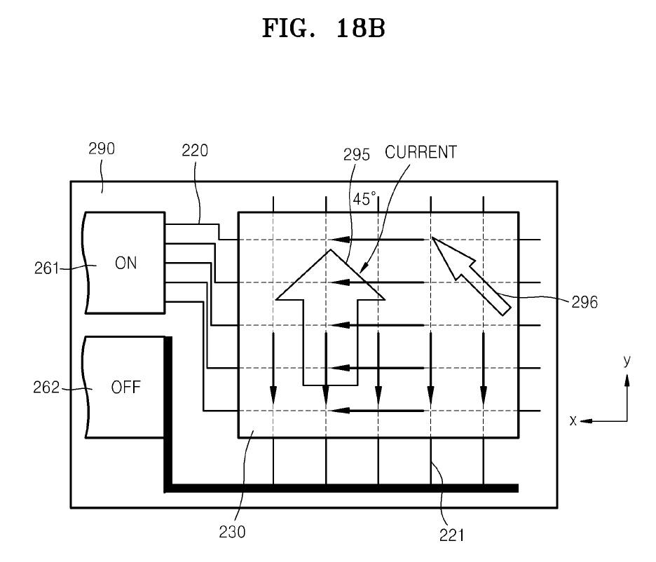

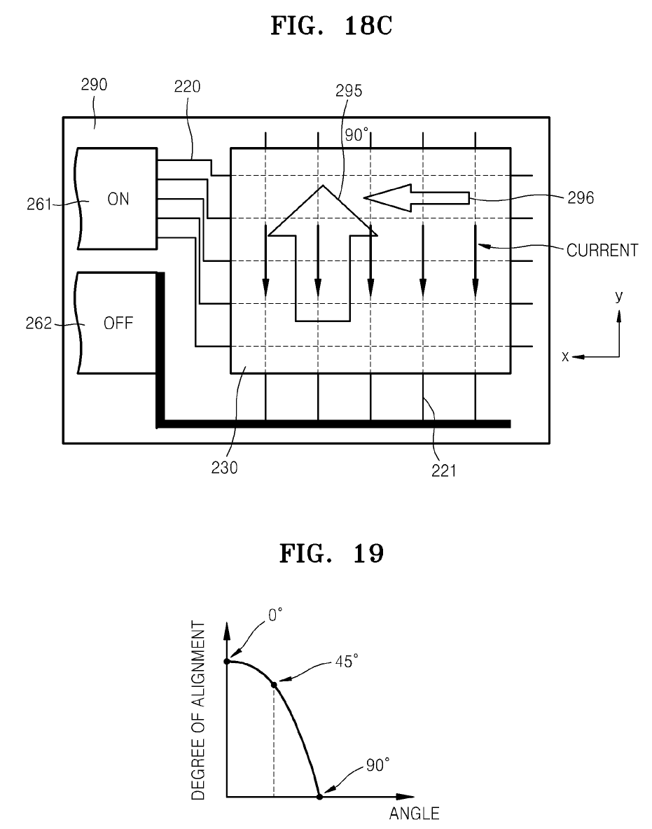

FIGS. 18A through 18C show the operation principle of a magnetic display sub-pixel 400 according to an embodiment of the present invention. That is, FIGS. 18A through 18C show how well the direction of a magnetic field applied to the magnetic material layer 230 is arranged with the direction of a magnetic field of the external polarizing plate 290 according to the operation of the first control circuit 261 and the second control circuit 262. In order to explain the operation principle of the present invention in a simpler way, the magnetic display pixel 400 illustrated in FIGS. 18A through 18C includes only the first control circuit 261, the second control circuit 262, the magnetic material layer 230, the first sub-pixel electrode 220 that is disposed under the magnetic material layer 230 and connected to the first and second control circuits 261 and 262, respectively, and the external polarizing plate 290 that is disposed at the lowermost end. Here, it is considered that the external polarizing plate 290 is an active reflective polarizing plate having the above-described magnetic material layer, and the direction of a magnetic field 295 that is applied to the magnetic material layer of the external polarizing plate 290 is the y-direction.

As illustrated in FIG. 18A, when a voltage is applied to a gate electrode of the TFT of the first control circuit 261, the TFT is turned on and a current flows through the first sub-pixel electrode 220 in the x-direction. Here, a magnetic field (H-field) 296 that is induced in the magnetic material layer 230 is formed in the y-direction, the same direction as the magnetic field 295 that is applied to the external polarizing plate 290. In this case, among light that is incident from a light source, light having the magnetic components that are perpendicular to the direction of the induced magnetic field of the magnetic material layer 230 and the direction of the induced magnetic field of the polarizing plate 290 is transmitted. On the other hand, as illustrated in FIG. 18C, when a voltage is applied to a gate electrode of a TFT of the second control circuit 262, the TFT is turned on, and a current flows through the second sub-pixel electrode 221 in the -y direction. Here, a magnetic field (H-field) 296 that is induced in the magnetic material layer 230 is formed in the x-direction. In this case, the direction of the induced magnetic field 295 of the external polarizing plate 290 and the direction of the induced magnetic field 296 of the magnetic material layer 230 are perpendicular to each other, and thus no light having any polarization components among incident light from a light source can be transmitted.

In FIGS. 18A and 18C, light is reflected or transmitted depending on whether the direction of the magnetic field 296 induced in the magnetic material layer 230 is parallel or perpendicular to the direction of the magnetic field 295 of the external polarizing plate 290. The intensity of the reflection or transmission of light changes like a cosine function as shown in FIG. 19. For example, referring to FIG. 18B, when a current of the same amount is applied to the first sub-pixel electrode 220 and the second sub-pixel electrode 221, the magnetic field 296 of the magnetic material layer 230 is induced in an xy direction. In other words, a magnetic field is induced in a direction adjusted clockwise at about 45 degrees to the x-direction, and magnetic moments of the magnetic material layer 230 are arranged in this direction. Accordingly, the direction of the magnetic field of the external polarizing plate 290 and the direction of the magnetic field of the magnetic material layer 230 cross each other at 45 degrees, and thus the intensity of light transmission becomes smaller than when the direction of the magnetic field of the external polarizing plate 290 and the direction of the magnetic field of the magnetic material layer 230 coincide with each other as illustrated in FIG. 18A. Thus, by varying the amount of current flowing through the first sub-pixel electrode 220 and the second sub-pixel electrode 221 the direction of the induced magnetic field applied to the magnetic material layer 230 can be changed between the y-direction to the x-direction and the intensity of transmitted light can be controlled like a cosine function.

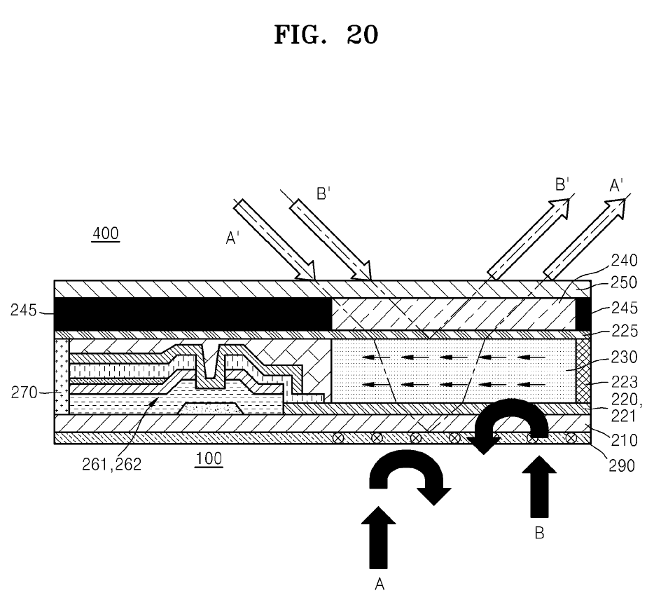

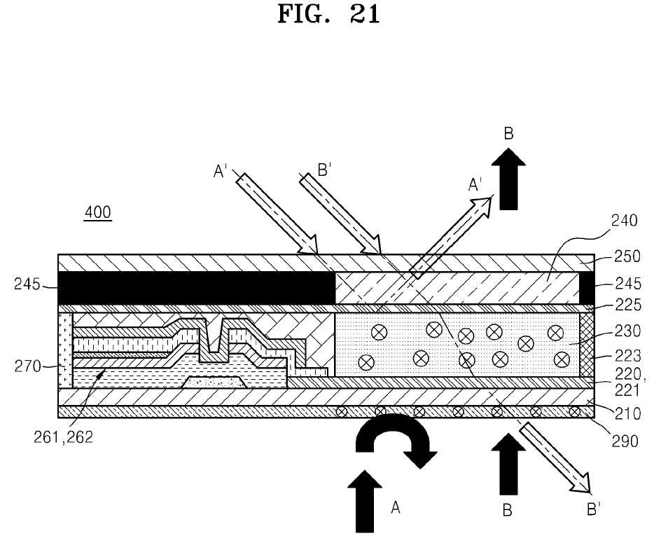

Hereinafter, referring to FIGS. 20 and 21, the operation principle of one sub-pixel 400 of the magnetic display panel illustrated in FIG. 17 will be described in more detail. The external polarizing plate 290 added to the lower surface of one sub-pixel 400 of the magnetic display panel may be reflective or absorptive. Here, however, the operation principle of one sub-pixel 400 of the magnetic display panel is described with reference to an active reflective polarizer. Also, it is considered here that when a drain current flows in the TFT of the first control circuit 261, a magnetic field in the same direction as the direction of a magnetic field induced in the magnetic material layer 230 is formed in the external polarizing plate 290. In this case, for example, when a drain current flows in the TFT of the first control circuit 261, one polarization light that is transmitted through the magnetic material layer 230 is also transmitted through the external polarizing plate 290 under the sub-pixel 400 of the magnetic display panel. Also, the magnetic material layer 230 formed of only a ferromagnetic material is considered.

FIG. 20 illustrates the magnetic display sub-pixel 400 when it is turned off. The fact that the magnetic display sub-pixel 400 is turned off does not mean that no current flows through the magnetic display sub-pixel 400 at all; instead, it means that a current flows but the direction of the magnetic field of the magnetic material layer 230 is perpendicular to the direction of the magnetic field of the external polarizing plate 290 and thus no light can be transmitted at all. The direction of the magnetic field of the external polarizing plate 290 is parallel or antiparallel to the direction of the magnetic field of the magnetic material layer 230 only when the first control circuit 261 is turned on and a current flows through the first sub-pixel electrode 220 (see FIG. 18A).

In FIG. 20, a current flows through the second control circuit 262 instead of through the first control circuit 261 so that the direction of the magnetic field of the magnetic material layer 230 is formed toward the x-axis and the direction of the magnetic field of the external polarizing plate 290 is formed in the direction going into page of drawing, and these directions are perpendicular to each other (see FIG. 18C). Accordingly, even when A polarization light among the light generated from a backlight light source (not shown) is reflected at the external polarizing plate 290, and B polarization light that is perpendicular to the A polarization light is transmitted by the external polarizing plate 290, the B polarization light is reflected at the magnetic material layer 230. As a result, as illustrated in FIG. 20, light generated in the backlight light source cannot be transmitted through the magnetic display sub-pixel 400 at all.

Meanwhile, if A′ polarization light from an external light source is in the same polarization direction as the A polarization component of the backlight light source, the A′ polarization light is transmitted through the magnetic material layer 230 and is reflected at the external polarizing plate 290. Also, if the B polarization light from the backlight light source and the B′ polarization light from an external light source are of the same polarization, the B′ polarization light is reflected on the surface of the magnetic material layer 230. The reflected B′ polarization light does not contribute to image formation but may make the eyes of an observer tired. Accordingly, an absorptive polarizing plate to absorb only the B′ polarization light may be disposed on at least one of optical surfaces from the magnetic material layer 230 to the second transparent substrate 250. Also, as already described with reference to FIG. 13, an anti-reflection coating may be formed on at least one of optical surfaces from the magnetic material layer 230 to the second transparent substrate 250.

FIG. 21 illustrates the magnetic display sub-pixel 400 when it is turned on. As the first control circuit 261 is turned on, the magnetic field of the magnetic material layer 230 is formed in the direction going into page of drawing, and the direction of a magnetic field of the external polarizing plate 290 is also formed into direction going into page of drawing, thereby the directions are parallel to each other. Accordingly, when A polarization light among light generated from a backlight light source is reflected at the external polarizing plate 290, B polarization light that is perpendicular to the A polarization light is transmitted through both the external polarizing plate 290 and the magnetic material layer 230. As a result, among light generated from a backlight light source, the B polarization light can transmit the magnetic display sub-pixel 400. Also, under a condition as illustrated in FIG. 21, among light generated from an external light source, the B′ polarization light is transmitted through both the magnetic material layer 230 and the external polarizing plate 290 and can exit from the lower surface of the magnetic display sub-pixel 400.

Referring to FIG. 21, the A′ polarization light from the external light source is reflected on the surface of the magnetic material layer 230 and thus is always in the background of the magnetic display panel. The reflected A′ polarization light does not contribute to image formation but may make the eyes of an observer tired. Accordingly, an anti-reflection coating may be formed on at least one of optical surfaces from the magnetic material layer 230 to the second transparent substrate 250 or an absorptive polarizing plate to absorb only the A′ polarization light may be added.

Also, the external light B′ that is transmitted through the magnetic material layer 230 and the external polarizing plate 290 and exits from the lower surface of the magnetic display sub-pixel 400 may be regarded as being wasted. In a very bright space, it may save energy to reduce the light B that comes from a backlight unit (BLU) and instead use the light B′ more. Accordingly, a reflection plate (not shown) may be attached to at least one of optical surfaces from the magnetic material layer 230 to the external polarizing plate 290 in order to use the magnetic display sub-pixel 400 as a reflective, semi-transmissive, or transmissive display pixel.

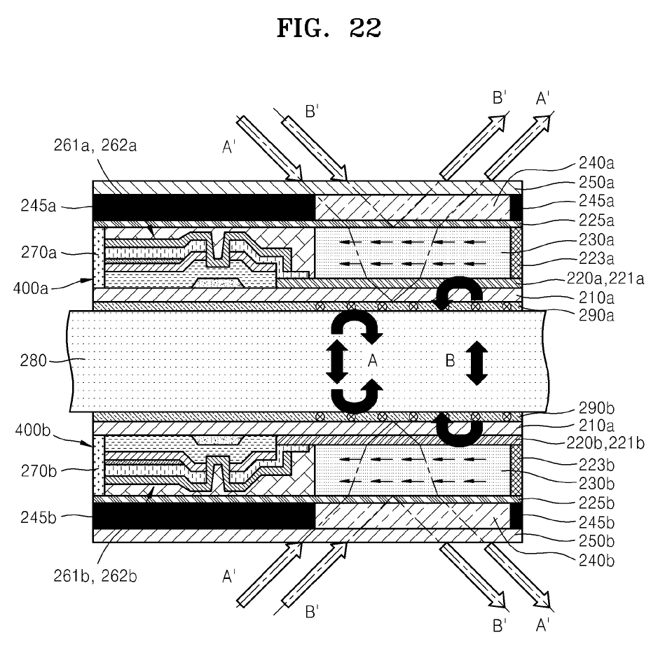

FIG. 22 is a cross-sectional view of a double-sided display panel using the structure of a sub-pixel of the magnetic display panel illustrated in FIG. 17, wherein only one sub-pixel is illustrated for convenience. Referring to FIG. 22, a sub-pixel 400a of the first magnetic display panel and a sub-pixel 400b of the second magnetic display panel are disposed symmetrically to each other on both sides of a backlight unit 280. The structure of the sub-pixels 400a and 400b of the first and second magnetic display panels is completely equal to that of the sub-pixel 400 of the magnetic display panel illustrated in FIG. 17, and thus a detailed description of the structure of the sub-pixels 400a and 400b of the first and second magnetic display panels will be omitted here. According to the present invention, the sub-pixels 400a and 400b of the first and second magnetic display panels disposed on both sides of the backlight unit 280 can be turned on and off individually. Furthermore, the direction of magnetic fields of magnetic material layers 230a and 230b can be controlled as described with reference to FIGS. 18A through 18C.

Referring to FIG. 22, the direction of the magnetic fields of all of the sub-pixels 400a and 400b of the first and second magnetic display panels is induced all in x-direction, and the direction of the magnetic fields of the external polarizing plates 290a and 290b is formed in a direction going into page of drawing. Accordingly, polarization light A and B generated from the backlight unit 280 cannot transmit the sub-pixels 400a and 400b of the first and second magnetic display panels. Meanwhile, A′ polarization light of the external light source is transmitted through the magnetic material layer 230a or 230b and is reflected at the external polarizing plate 290a or 290b, and B′ polarization light of the external light source is reflected on the surface of the magnetic material layer 230a or 230b.

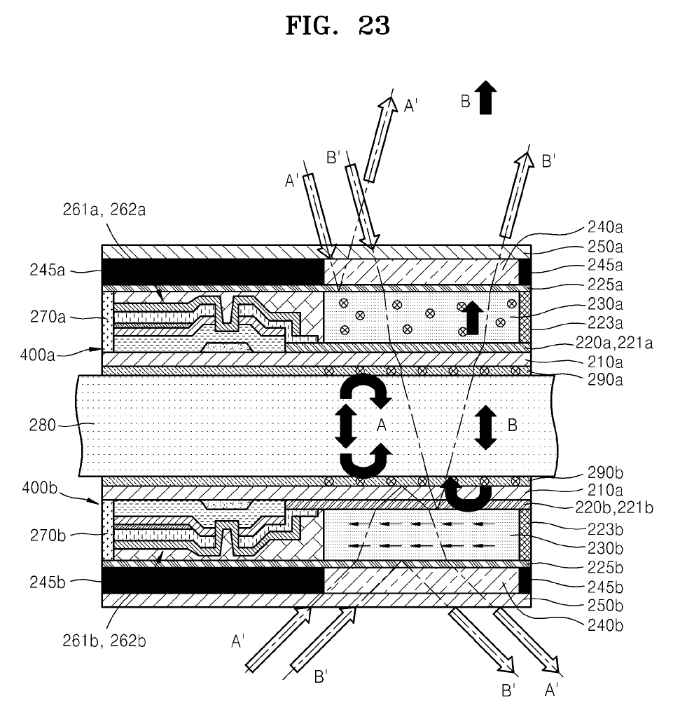

FIG. 23 is a cross-sectional view illustrating another operation of a double-sided display panel according to an embodiment of the present invention. In FIG. 23, the sub-pixel 400a of the first magnetic display panel is turned on, and the sub-pixel 400b of the second magnetic display panel is turned off. In this case, the sub-pixel 400b of the second magnetic display panel is turned off, and thus light A and B from the backlight unit 280 and external light A′ and B′ incident on the sub-pixel 400b of the second magnetic display panel are all reflected by the external polarizing plate 290b and the magnetic material layer 230b.

On the other hand, the sub-pixel 400a of the first magnetic display panel is turned on, and thus light B having a polarization component that is perpendicular to the direction of the magnetic field of the external polarizing plate 290a among light incident to the magnetic material layer 230a through the first transparent substrate 210a from the backlight unit 280 is transmitted through the external polarizing plate 290a. Then the light B is also transmitted through the magnetic material layer 230a in which magnetic moments are arranged in the same direction as the direction of the magnetic field of the external polarizing plate 290a, and thus the light B contributes to image formation of the sub-pixel 400a of the first magnetic display panel. Also, light A having a parallel polarization component is reflected by the external polarizing plate 290a of the sub-pixel 400a of the first magnetic display panel. The light A having parallel polarization component A can be reflected again in the external polarizing plate 290b of the sub-pixel 400b of the second magnetic display panel after being reflected by the external polarizing plate 290a of the sub-pixel 400a of the first magnetic display panel. Accordingly, when a diffusion plate or a polarization converter is provided in the backlight unit 280, the light A having the reflected parallel polarization component can be converted to unpolarized light and used again.

The magnetic display panel according to the present invention can be applied not only to solid flat panel displays but also to flexible displays that can be easily bent. In the case of conventional liquid crystal displays, a high temperature process is required and thus flexible substrates which are vulnerable to high temperature could not be used, and thus were difficult to apply to flexible displays. The magnetic material layer 230 according to the present invention, however, can be manufactured at a relatively low temperature of about 130° C., and thus the magnetic display panel according to the present invention can be applied to flexible display devices.

In order to apply the magnetic display panel according to the present invention to flexible displays, all components should be formed of flexible materials. For example, referring to FIG. 17, the first and second transparent substrates 210 and 250 can be formed of light transmitting resin such as polyethylene naphtalate (PEN), polycarbonate (PC), and polyethylene terephthalate (PET). Also, the sub-pixel electrodes 220 and 221 and the common electrodes 225 and 226 may be formed of, for example, a conductive polymer such as iodine-doped polyacetylene. The iodine-doped polyacetylene has similar conductivity to silver but is opaque and thus is not used for conventional liquid crystal display panels. However, as described above, it does not matter when the sub-pixel electrodes 220 and 221 and the common electrodes 225 and 226 are not transparent.

The control circuits 261 and 262 may be formed of organic TFTs that are well known and that are often used for conventional flexible organic ElectroLuminescent (EL) displays (or flexible Organic Light Emitting Device (OLED) displays). Also, a mirror or a semi-transmissive mirror that can be formed on at least one of optical surfaces from the magnetic material layer 230 to the first transparent substrate 210 may be preferably formed of a dielectric mirror and not of a metal mirror. The backlight unit, also, can be formed of a flexible light guide plate that is formed of the above described flexible light transmitting material, and a direct type backlight unit may be formed of a flexible substrate and a light source disposed on the flexible substrate.

Meanwhile, when the magnetic display panel according to the present invention is applied to paperlike flexible displays that can be used once and then discarded afterwards like newspaper, the light source may be a glow material instead of a backlight unit. For example, a glow material such as copper-activated zinc sulfide (ZnS:Cu) or copper and magnesium activated zinc sulfide (ZnS:Cu,Mg) can be used as a light source instead of a backlight unit.

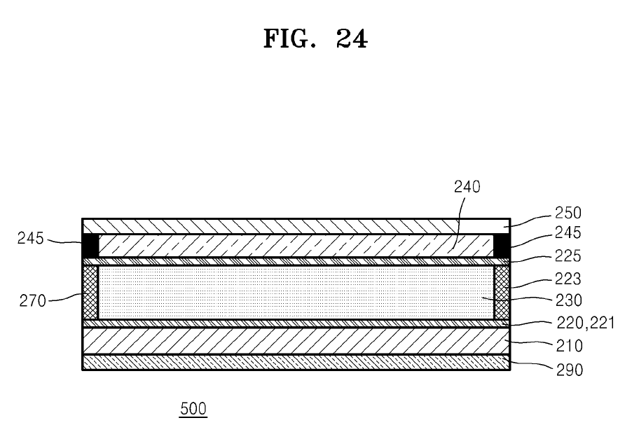

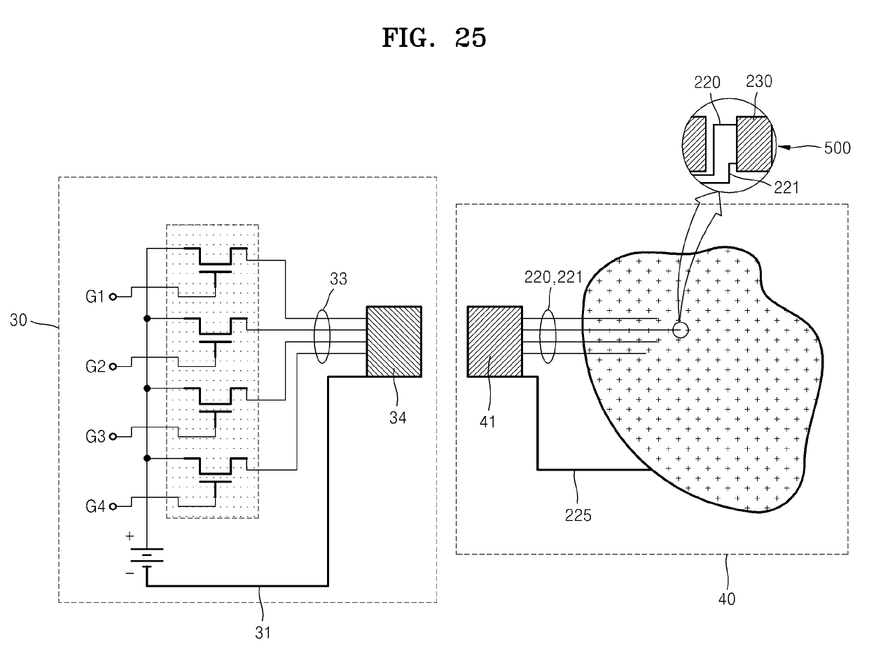

Also, as another example of the flexible displays, an inorganic TFT may be used instead of an organic TFT. An inorganic TFT has a solid structure and requires a high temperature structure, and thus the inorganic TFT is separated from the structure of the sub-pixel and a flexible display unit and control unit are manufactured separately. FIG. 24 illustrates a sub-pixel 500 of the flexible magnetic display panel. The sub-pixel 500 of the flexible magnetic display panel illustrated in FIG. 24 is different from the sub-pixel 400 of the magnetic display panel illustrated in FIG. 17 in that control circuits 261 and 262 are removed from the sub-pixel 500. The rest of the structure of the sub-pixel 500 of the magnetic display panel illustrated in FIG. 24 is the same as the sub-pixel 400 of the magnetic display panel illustrated in FIG. 17. Also, the first and second transparent substrates 210 and 250, the sub-pixel electrodes 220 and 221, and the common electrode 225 are formed of the above-described flexible material.

Thus, as illustrated in FIG. 25, a control unit 30 formed of inorganic thin film transistors, for driving each of the sub-pixels, and a separate flexible display unit 40 from which the control circuits 261 and 262 such as transistors are removed, are provided. The control unit 30 is formed of a plurality of inorganic TFTs that respectively correspond to sub-pixels, and includes a first connector 34 to connect with the flexible display unit 40. The first connector 34 is electrically connected to sub-pixel electrodes 33 extending from a drain of the plurality of inorganic TFTs at the control unit and to a common electrode 31 at the control unit that is extended from the source. Also, the flexible display unit 40 includes a second connector 41 that is combined with the first connector 34 of the control unit 30. The second connector 41 is electrically connected to the sub-pixel electrodes 220 and 221 and the common electrode 225 of the flexible display unit 40. Accordingly, when combining the first connector 34 and the second connector 41, each of the sub-pixels 500 in the flexible display unit 40 can be turned on and off by the control unit 30.

The active reflective polarizer according to the present invention is a polarizer using magnetic characteristics and the polarization direction of a polarizer can be controlled. Thus a magnetic display device can be realized using the active reflective polarizer. Also, the size of the active reflective polarizer according to the present invention is not restricted.

The magnetic display pixel according to the present invention can form an optical shutter that controls projection and blocking of light by using fewer components than conventional liquid crystal display pixels. Accordingly, a display panel can be manufactured in a simpler way at lower costs than conventional liquid crystal display panels.

Also, the magnetic display panel according to the present invention can use most of the manufacturing processes of the conventional liquid crystal display panels, and thus the currently used manufacturing lines for conventional liquid crystal display panels can be used as they are.

Moreover, since a high temperature process is not required for a magnetic display panel, the magnetic display panel can be applied to flexible display devices.

The magnetic display panel according to the present invention can be manufactured not only as a small surface but also as a large surface. Accordingly, the magnetic display panel according to the present invention can be widely applied to electronic devices having various sizes in which a screen is provided, for example, TVs, PCs, laptop computers, mobile phones, PMPs, game devices, etc.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A reflective polarizer comprising:
a magnetic material layer including magnetic moments; and
electrodes which generate magnetic fields in two directions that are received at the magnetic material layer,
wherein a direction of the magnetic moments of the magnetic material layer changes according to intensities of the magnetic fields generated in the two directions.

2. The reflective polarizer of claim 1, wherein light having a magnetic component parallel to the direction of magnetic moments of the magnetic material layer is reflected at the magnetic material layer, and light having a magnetic component perpendicular to the direction of magnetic moments is transmitted through the magnetic material layer.

3. The reflective polarizer of claim 1, wherein the magnetic material layer comprises:
a transparent insulating medium; and
magnetic particles buried in the transparent insulating medium, wherein a thickness of the magnetic material layer is greater than a magnetic decay length of the magnetic material layer.

4. The reflective polarizer of claim 3, wherein the magnetic material layer comprises core-shell structures including magnetic cores and transparent insulating shells around the magnetic cores.

5. The reflective polarizer of claim 4, wherein the magnetic cores comprise one of metals selected from the group consisting of iron, cobalt, nickel, titanium, aluminum, barium, platinum, natrium, magnesium, dysprosium, manganese, gadolinium, silver, copper, and chromium, or an alloy comprising at least two metals of the group.

6. The reflective polarizer of claim 1, wherein the electrodes comprises a first electrode generating a magnetic field in a first direction and a second electrode generating a magnetic field in a second direction perpendicular to the first direction.

7. The reflective polarizer of claim 6, wherein the electrodes are grid-wire type electrodes or planar type electrodes.

8. The reflective polarizer of claim 7, wherein a light-transmitting insulating material is inserted between wires of the grid-wire type electrodes.

9. The reflective polarizer of claim 1, wherein the electrodes comprise at least one of In, Au, Sn, Pt, Pd, Al, Cu, Ag, Mg, Zn, Sc, Hf, Zr, Te, Se, Ta, W, Nb, Si, Ni, Co, Mo, Cr, Mn, Hg, Pr, La based elements, and iodine-doped polyacetylene elements.

10. A display pixel comprising:
a magnetic material layer including magnetic moments;
a first electrode and a second electrode which generate magnetic fields in two directions that are received at the magnetic material layer;
a third electrode electrically connected to the first electrode and the second electrode; and
a control circuit that switches a current flow between the first electrode and the third electrode and between the second electrode and the third electrode,
wherein the direction of the magnetic moments of the magnetic material layer changes according to intensities of the magnetic fields generated in the two directions by the first electrode and the second electrode, respectively.

11. The display pixel of claim 10, wherein the magnetic material layer comprises:
a transparent medium; and
magnetic particles buried in the transparent insulating medium, wherein a thickness of the magnetic material layer is greater than a magnetic decay length of the magnetic material layer.

12. The display pixel of claim 11, wherein the magnetic material layer includes core-shell structures including magnetic cores and transparent insulating shells around the magnetic cores.

13. The display pixel of claim 12, wherein the magnetic cores comprise one of metals selected from the group consisting of iron, cobalt, nickel, titanium, aluminum, barium, platinum, natrium, magnesium, dysprosium, manganese, gadolinium, silver, copper, and chromium, or an alloy comprising at least two metals of the group.

14. The display pixel of claim 10, wherein the first and the second electrodes are grid-wire type electrodes or planar type electrodes.

15. The display pixel of claim 10, further comprising a first conductive spacer electrically connecting the first electrode and the third electrode and a second conductive spacer electrically connecting the second electrode and the third electrode, which are disposed at a side of the magnetic material layer.

16. The display pixel of claim 15, wherein the third electrode is a planar sheet or a wire in a grid structure that is electrically connected to the first and the second conductive spacers.

17. The display pixel of claim 16, wherein the third electrode is formed of a first common electrode that is electrically connected to the first electrode and a second common electrode that is electrically connected to the second electrode.

18. The display pixel of claim 17, wherein the first and second electrodes, and the first and the second common electrodes comprise at least one of In, Au, Sn, Pt, Pd, Al, Cu, Ag, Mg, Zn, Sc, Hf, Zr, Te, Se, Ta, W, Nb, Si, Ni, Co, Mo, Cr, Mn, Hg, Pr, La based elements, and iodine-doped polyacetylene elements.

19. The display pixel of claim 10, further comprising an external polarizing plate formed at a side of the display pixel.

20. The display pixel of claim 10, further comprising a first transparent substrate and a second transparent substrate that are respectively disposed at a rear surface and a front surface of the magnetic display pixel.

21. The display pixel of claim 20, further comprising a color filter disposed between the magnetic material layer and the second transparent substrate.

22. A display panel comprising a plurality of display pixels, wherein one of the plurality of display pixels comprises:
a magnetic material layer including magnetic moments;
a first electrode and a second electrode which generate magnetic fields in two directions that are received at the magnetic material layer;
a third electrode that is electrically connected to the first electrode and the second electrode; and
a control circuit that switches a current flow between the first electrode and the third electrode and between the second electrode and the third electrode,
wherein the direction of the magnetic moments of the magnetic material layer changes according to intensities of the magnetic fields generated in the two directions by the first electrode and the second electrode.

23. The display panel of claim 22, wherein the plurality of display pixels are disposed two-dimensionally between first and second transparent substrates that are common to the magnetic display pixels, and the magnetic material layer and the first and the second electrodes which generate magnetic fields that are received at the magnetic material layer, are arranged in each of the plurality of display pixels, and each of the plurality of display pixels forms a sub-pixel.

24. The display panel of claim 23, wherein the display panel is a flexible display panel formed of the first transparent substrate, the second transparent substrate, the first electrode, the second electrode, and the third electrode, which are formed of a flexible material.

25. The display panel of claim 24, wherein the display panel comprises a display unit in which the plurality of display pixels are disposed and a separate controlling unit that individually switches current flow between the first electrode, the second electrode, and the third electrode for each of the plurality of display pixels.

26. The reflective polarizer of claim 1, wherein increasing a current in one of the electrodes increases a magnetic intensity generated in one of the two directions so that the direction of the magnetic moments of the magnetic material layer is closer to the one of the two directions.
